(19) United States
(12) Patent Application Publication
(10) Pub. No.: US 2005/0262379 A1
(43) Pub. Date: Nov. 24, 2005

(54) Forestalling long time-outs in processes

(75) Inventor: Albertus Visser, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKILIJKE PHILLIPS N.V.

(21) Appl. No.: 10/521,711

(22) PCT Filed: Jun. 25, 2003
(86) PCT No.: PCT/IB03/02851

§ 371 Date: Jan. 19, 2005

(30) Foreign Application Priority Data
Jul. 24, 2002 (EP) 02078022.7

(51) Int. Cl. G06F 11/00

(52) U.S. Cl. 714/4

(57) ABSTRACT

The present invention relates to methods, devices, systems and computer program products which avoid long time-outs in processes run on two or more computers. A first computer (10) comprises an application unit (16) performing computational tasks, and a status determining unit (20) connected to the application unit. The status determining unit sends a request for status to a second computer (14), which second computer is to perform some computational tasks for the application unit, and automatically blocks request for processing of data to the second computer if no response is received from the second computer, where the request for processing is caused by the application. The second computer comprises an application unit (26) performing the computational tasks and a status responding unit (22) which receives the request for status from the first computer, generates at least one response to the request, and sends the response to the first computer.

The present invention generally relates to the field of computers and computer networks and in particular to devices, methods, systems and computer program products used for forestalling long time-outs in processes run on two or more computers.

In the field of computers it is well known to have a process running on one computer, which from time to time needs to have some computations made on another computer. This type of communication is normally provided in the form of session oriented client-server communication.

In these types of systems the client calls the server with a request for data processing. One type of software providing this type of functionality is the Distributed Component Model (DCOM) provided by Microsoft. In DCOM a remote procedure call (RPC) is made from a client to a server using TCP/IP as protocol. Because of instability of the network these calls can be hanging for very long periods of time if the server or client has lost its network connection. This is due to the fact that the DCOM tries to repeat calling the server several times before an error signal is generated. These types of time outs can be as long as 6 minutes, which is unacceptable in many applications.

EP 940 750 describes a system including a client and a server, where when sending a message from a client object to a server object a data area is reserved. If processing executed by the server object is correctly completed, the data indicating the processing result is stored in the data area. If processing executed by the server object is not correctly completed, the data indicating the status of the server object is stored in the data area. By reading the data in the data area, the client object receives the data of the processing result if the processing on the server object has been correctly completed. If the processing of the server object has not been correctly completed, the client object receives the status data. This document does however not describe how long time-outs can be avoided if processing cannot be completed, for instance because of no network connection.

The present invention is directed towards solving the problem of long time-outs occurring when calls for processing are made to servers having problems giving computational results to a client. The invention is thus directed towards providing a client, which makes it possible to avoid long time-outs.

This problem is solved by a method of forestaling long time-outs in a process run on at least a first computing device in a network, which process makes calls for processing to a second computing device, and comprising the steps of: sending a request for status to a second computing device, and in case of no response on the request for status from the second computing device automatically blocking requests for processing of data to be sent the second computing device.

This problem is also solved by a computing device for connection to other computing devices via a network comprising: an application unit performing computational tasks and making requests for processing to another computer device, a status determining unit connected to the application unit and arranged to send a request for status to the other computing device, which other computing device is to perform a computational task for the application unit, and automatically block request for processing of data to the second computing device if no response is received from the other computing device, which request for processing is caused by the application.

This problem is also solved by a program product comprising a computer readable medium, having thereon: computer program code means, to make a computer execute, when said program is loaded in the computer: sending of a request for status to another computer, and in case of no response on the request for status from the other computer, automatically blocking requests for processing of data to the other computer.

According to another aspect of the invention, there is provided a method and a server, which facilitates the avoiding of long-time outs in a client.

This is achieved by a method of determining status of a computing device used for receiving calls for processing from another computing device via a network, comprising the steps of: receiving a request for status from the other computing device, generating at least one response to the request, and sending the response to the other computing device.

This is also achieved by a computing device for connection to other computing devices via a network and comprising: an application unit performing computational tasks for another computational unit when being requested to do so by the other computing device and a status responding unit arranged to receive a request for status from the other computing device, generate at least one response to the request, and send the response to the other computing device.

This is also achieved by a program product comprising a computer readable medium, having thereon: computer program code means to make a computer execute, when said program is loaded in the computer: receiving a request for status from another computer, generating at least one response to the request, and sending the response to the other computer.

According to yet another aspect of the invention there is provided a computer network, which makes it possible to avoid long time-outs between a client and a server present in normal networks.

This is achieved by a system of computing devices including at least a first and a second computing device connected to each other via a network, the first computing device comprising: an application unit performing computational tasks, a status determining unit connected to the application unit and arranged to send a request for status to the second computing device, which second computing device is to perform some computational tasks for the application unit, and automatically block request for processing of data to the second computing device if no response is received from the second computing device, which request for processing is caused by the application, the second computing device comprising: an application unit performing computational tasks for the first computational unit and a status responding unit arranged to receive the request for status from the first computing device, generate at least one response to the request, and send the response to the first computing device.

These and other aspects of the invention will be apparent from and elucidated with reference to the embodiments described hereinafter.

The present invention will in the following be described with reference made to the accompanying drawings, in which

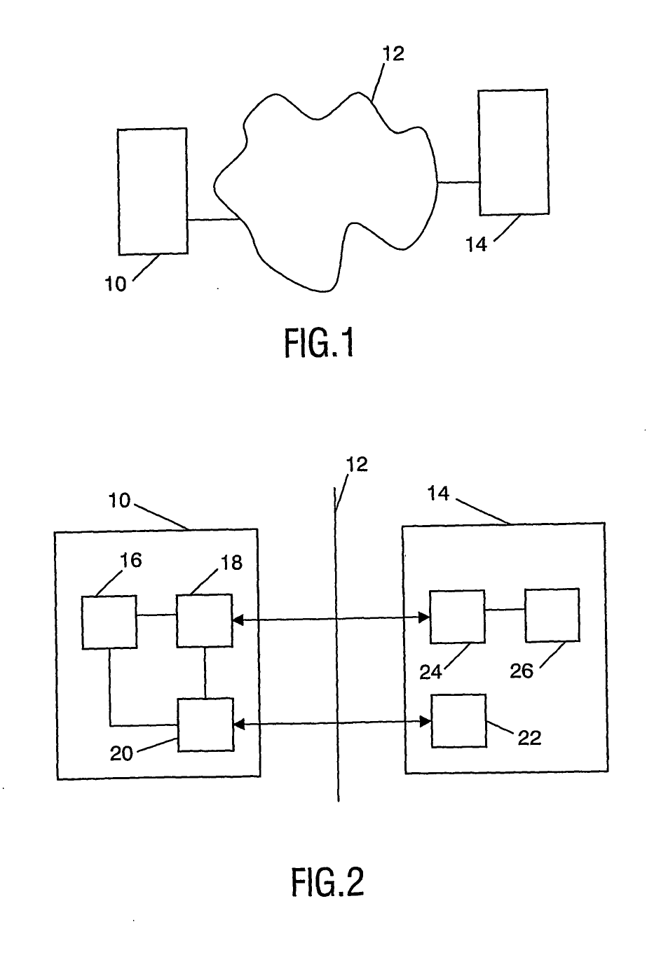

FIG. 1 shows a schematic drawing of two computer devices connected to each other via a network,

FIG. 2 shows a block schematic of the two computer devices of FIG. 1,

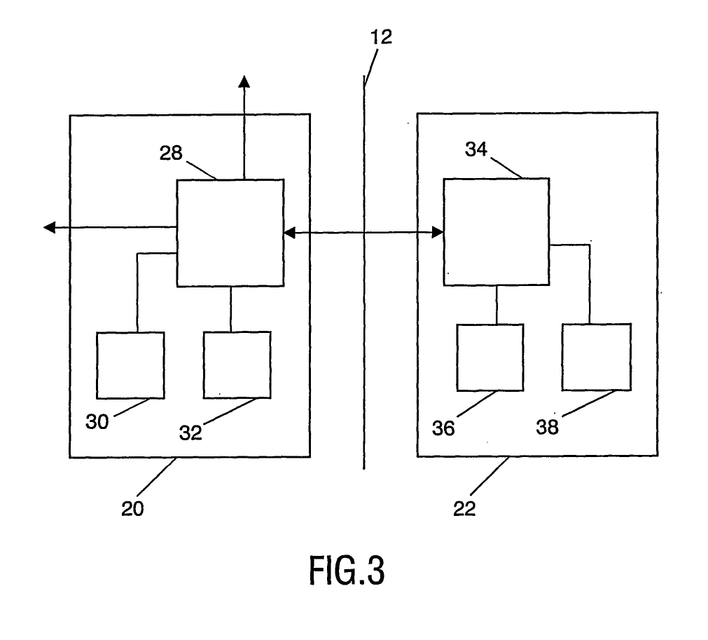

FIG. 3 shows a block schematic of a status determining unit in a first computing device connected to a status responding unit in a second computing device,

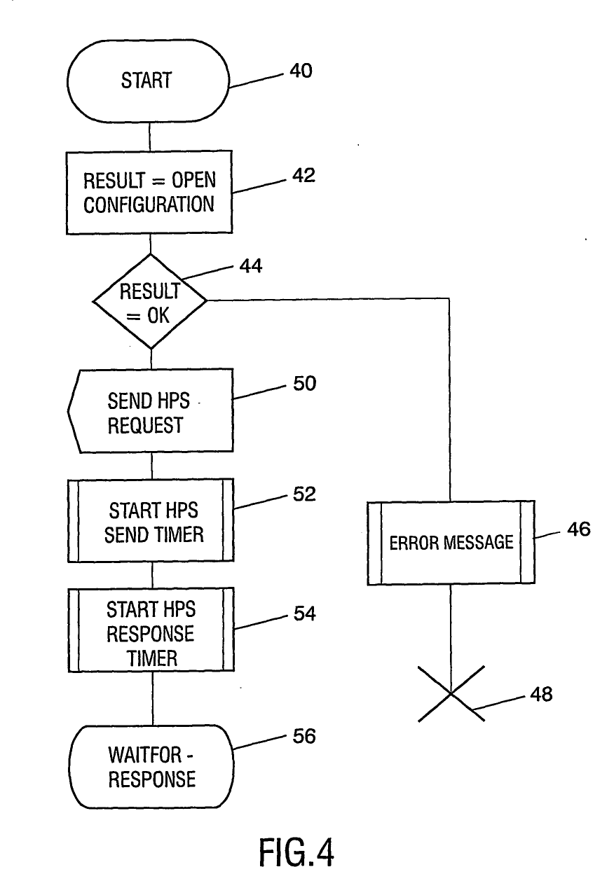

FIG. 4 shows a flow chart of a first part of a first method according to the invention performed in the first computing device,

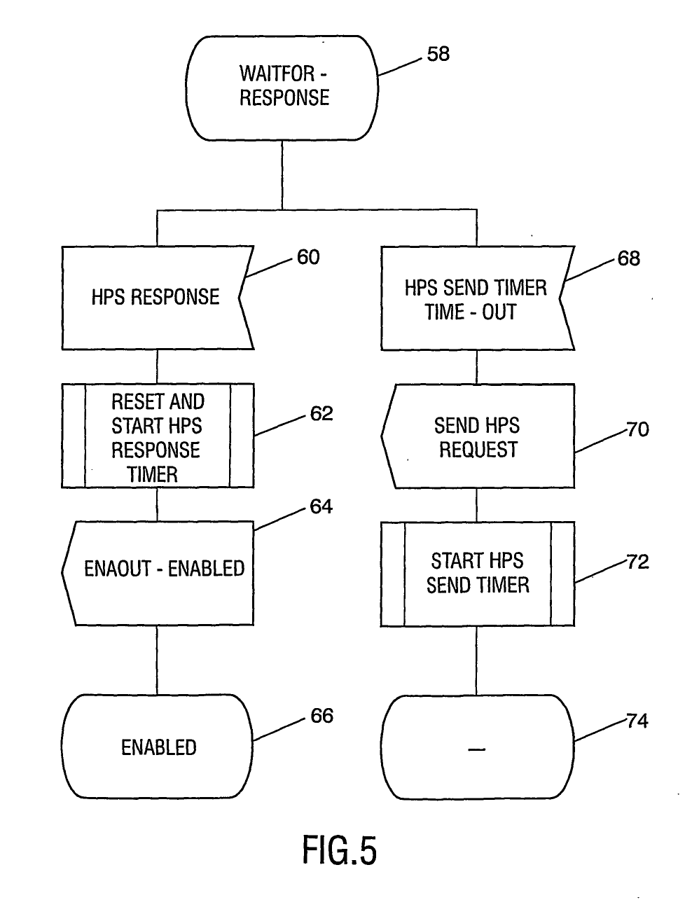

FIG. 5 shows a flow chart of a second part of the first method,

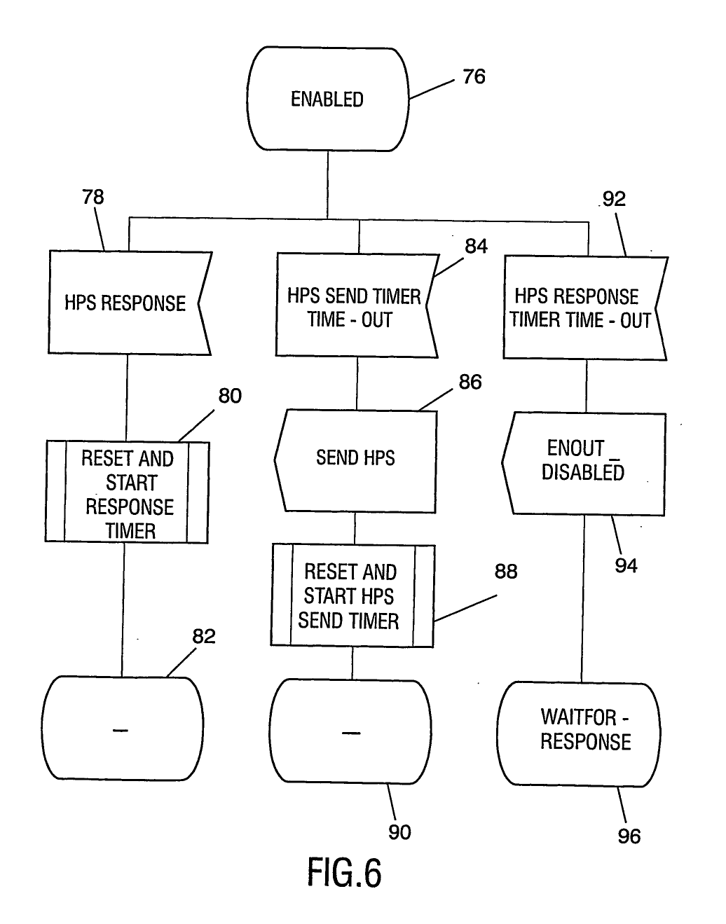

FIG. 6 shows a flow chart of a third part of the first method,

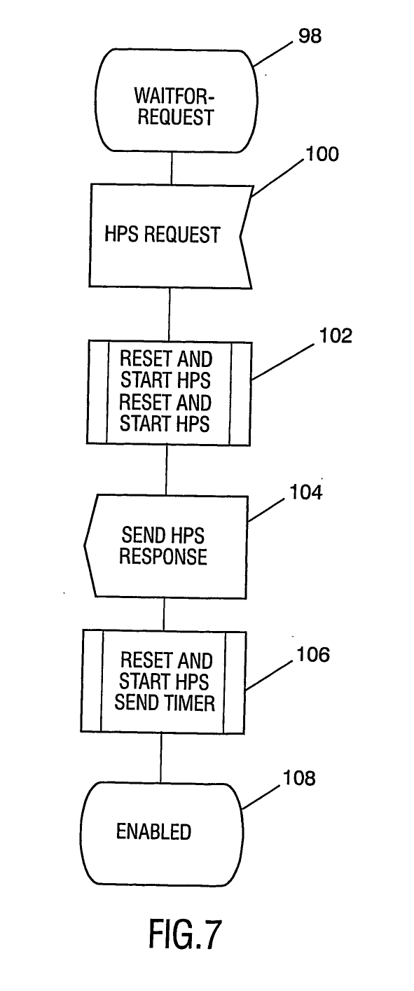

FIG. 7 shows a flow chart of a first part of a second method according to the invention performed in the second computing device,

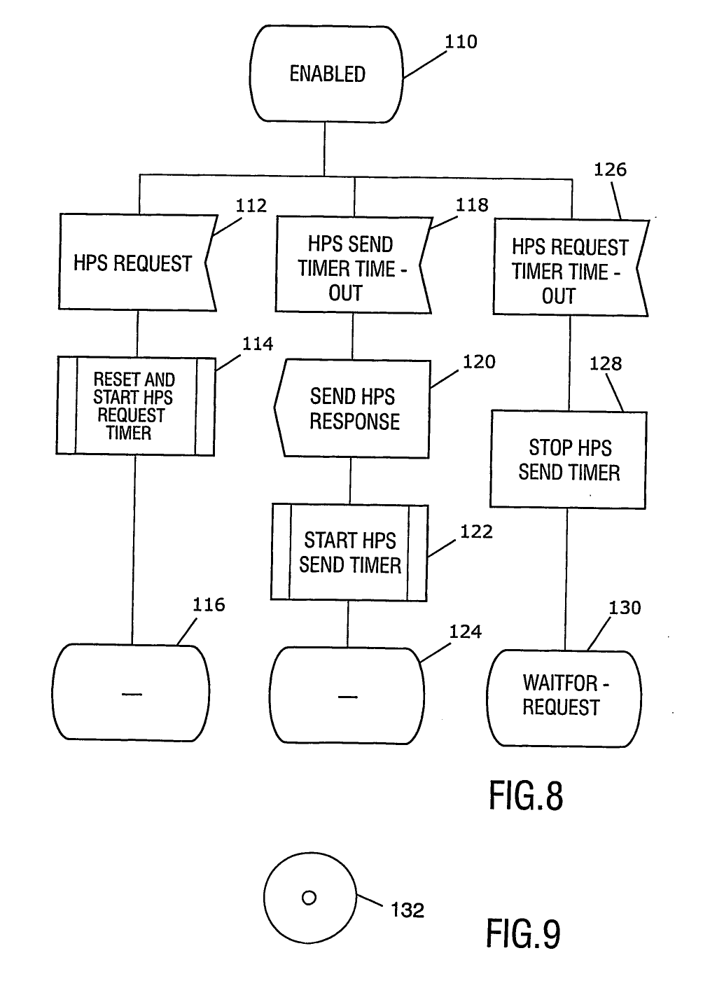

FIG. 8 shows a flow chart of a second part of the second method, and

FIG. 9 shows a computer readable medium, where program code for performing the first and/or the second method is stored.

Two computing devices or computers 10, 14 are connected to each other via a computer network 12. The network supports at least two types of communication protocols like TCP/IP and UDP/IP. In FIG. 1 is only shown two computers for easier understanding of the invention. It should be understood that more computers can readily be connected to the network.

FIG. 2 shows a simplified block schematic of the two computers 10 and 14 connected to each other via the network 12. Here the network 12 is shown as a straight line. A first of the computers 10 is a so-called client, while a second of the computers 14 is a server. The first computer 10 has an application unit 16 connected to a client DCOM (Distributed Component Model) unit 18, which communicates with a corresponding server DCOM unit 24 in the second computer 14. The application unit 16 and the DCOM unit 18 are also connected to a first status determining unit or HPS (Host polling service) client 20, which also communicates with a status responding unit or HPS server 22 in the second computer 14. The server DCOM unit 24 is connected to a server application unit 26 for performing different computing tasks for the client application. When the client DCOM unit 18 calls the second computer 14, there can be long time-outs if the second computer has no network connection. This is due to the fact that the client DCOM unit 18 will retry calling the second computer several times before an error is generated. This is not acceptable and the present invention solves this problem through the use of the status determining unit 20 in the first computer 10 with the help of the status responding unit 22 in the second computer.

FIG. 3 shows a block schematic of the status determining unit 20 of the first computer connected to the status responding unit 22 of the second computer via network 12. Also here the network 12 is depicted in the form of a straight line.

The status determining unit 20 includes a client control unit 28, which is connected to the DCOM unit (indicated with the arrow pointing upwards) and to the application unit (indicated with the arrow pointing to the left). The client control unit 28 is connected to a client send timer 30 and to a response timer 32. The client control unit 28 communicates with a server control unit 34 of the second computer via network 12. The server control unit 34 is connected to a request timer 38 and to a server send timer 36.

The functioning of the device will now be described in more detail. The application unit 16 is running some kind of application. It can for instance be some kind of e-mail application or network file system or a customer specific client/server application. When the application needs some processing to be done by the server, like for instance to fetch newly received e-mails, it connects to the client DCOM unit 18 and requests processing of data in order to make a DCOM call to the server. DCOM calls are normally performed by using the TCP/IP protocol. At the same time the application connects to the client control unit 28 of the status determining unit or HPS (host polling service) client 20 and also sends the request for processing to this control unit. When the client control unit 28 receives this request it starts performing the first part of the method depicted in FIG. 4. The method is thus started by the reception of a request for a DCOM call by the application, step 40. Once the method is started by a first DCOM call by the application, it continues monitoring any successive DCOM calls made by the application. The client control unit 28 reads the configuration for HPS servers it has to poll, step 42, which should be an open configuration. If the result of the check for configuration is not ok, step 44, an error message is generated, step 46, the error is logged and the HPS client terminates, step 48. If the result is ok, step 44, a request for status or an HPS request is sent from the client control unit 28 to the server control unit 34, step 50. This request is sent on a special port dedicated to this type of polling and is sent as an empty request packet using UDP/IP (User Datagram Protocol/Internet Protocol) as protocol. The packet includes source and destination port numbers, an indication of packet length and a check sum as header and only a zero as data or payload, where zero indicates a request message. The client control unit 28 also starts the client send timer or HPS send timer 30, step 52, and the response timer or HPS response timer 32, step 54. Thereafter the client control unit 28 enters a state WaitforResponse, step 56.

The WaitforResponse state is shown in FIG. 5. In the state WaitforResponse, step 58, the client control unit has two options based on different events. In the event of the control unit receiving an HPS response, step 60, it resets and starts the HPS response timer 32, step 62, and thereafter connects to the DCOM unit 18 enabling DCOM communication by sending a signal EnaOut_Enabled, step 64, and thereafter enters an enabled state, step 66. The format of the HPS response will be described later in relation to the HPS server. The response is received on the same special port number as the request is sent on.

The client control unit 28 continuously checks the status of the HPS send timer 30. In the event of the send timer 30 has reached a time out, step 68, the client control unit 28 decides to send yet another request, step 70 and resets and starts the send timer 30, step 72. The control unit then finishes, step 74 and returns to the original state, WaitforResponse, step 58.

FIG. 6 shows what happens in the state Enabled. In the state enabled, step 76, the client control unit has three options based on different events. If it receives an HPS response, step 78, it resets and starts the HPS response timer 32, step 80, then finishes, step 82, and thereafter returns to the initial enabled state, step 76.

The client control unit 28 checks the send timer 30 and in the event of the client HPS send timer has reached a send timer time-out, step 84, the client control unit sends an HPS request, step 86, and thereafter resets and starts the send timer 30, step 88. When this is done, the control unit 28 finishes, step 90, and returns to the initial enabled state, step 76.

The client control unit also checks the response timer 32 and in the event of the HPS response timer has reached a response timer time-out, step 92, the client control unit 28 disables DCOM communication by sending a signal EnaOut_Disabled signal to the client DCOM unit, step 94, thereafter the control unit 28 returns to the WaitforResponse state, step 96, which was described earlier in relation to FIG. 5. Thus DCOM-calls are disabled if no HPS response has been received before the response timer time-out.

Now the working of the server control unit 34 in the second computer will be described together with the flow charts of FIGS. 7 and 8. Turning first to FIG. 7, the server control unit 34 is initially in a state WaitforRequest, step 98, where it stays until it receives an HPS request from the client, step 100. After it has received this request the server control unit 34 resets and starts the HPS request timer 38, step 102 and thereafter sends an HPS response, step 104. The HPS response has exactly the same type of header as the received request. The only difference is that the payload or data is a one instead of a zero. This one indicates a response to the request. This message is also sent using UDP/IP. The request and the response are sent and received on the same special port, having the same port number as the HPS client uses. Thereafter the server control unit 34 also resets and starts the server HPS send timer 36, step 106, whereupon it enters an enabled state, step 108.

The enabled state is depicted in FIG. 8. In the enabled state, step 110, the server control unit 34 has three options based on different events. If an HPS request is received, step 112, the server control unit 34 resets and starts the HPS request timer 38, step 114, whereupon the server control unit 34 finishes, step 116, and returns to the initial enabled state, step 110. The server control unit 34 continuously checks the server send timer 36 and if a send timer time out occurs, step 118, an HPS response is sent, step 120, the HPS send timer is reset and started again, step 122, whereupon the control unit finishes, step 124 and returns to the initial enabled state 110. The control unit 34 also monitors the request timer 38 and if an HPS request timer time-out occurs, step 126, the control unit 34 stops the send timer 36, step 128 and enters state WaitforRequest, step 130, which state was described in relation to FIG. 7.

Time-outs are handled in the following way. The timer value is compared with a set time-out value in the corresponding control unit and if the set value is reached by the timer, the corresponding action is performed by the control unit in question.

The timer values should match the criteria set for detecting failures at fail-over times.

The client HPS response timer must be set at 2.5 times the server HPS send timer. This allows for missing one HPS response packet by the HPS client.

The server HPS request timer must be at least 1.5 times the client HPS send timer in order to be able to send two responses before a possible independent transmission is halted. Tables outlining preferred timer settings are given below.

| | Timer Setting |
|---|---|
| Client Timer | 5 seconds |
| HPS response timer | 2 seconds |
| HPS send timer | |
| Server Timer | |
| HPS request timer | 3 seconds |
| HPS send timer | 2 seconds |

The DCOM unit 18 finally works in the following way. When it receives a request for a DCOM call by the application it checks if it has received an EnaOut_enabled signal from the client control unit prior to making the call. If it has not, it returns a fail message immediately to the application. This can for instance be realized with a bit of code like the following:

If (HostEnabled)
{

HRESULT DCOMFunct1(par1, par2, par3);

}
else
{

HRESULT = E_FAIL;

}

The present invention has been described in the context of control units and timer units. These are preferably provided in the form of one or more processors together with appropriate program memory containing software performing the method. This software can also be provided on computer readable mediums, like CD-ROM discs, for loading into a computer. FIG. 9 shows such a disc 132 containing this program code either for the client, the server or both. This disc can naturally also contain the above described program code for the DCOM unit.

The described invention has several advantages. By using a simplified protocol for checking status of the server, it is possible to get fast responses especially in case of network failures. In this way calls for processing to a server can be blocked when there is no network connection. The application returns faster and doesn't seem to ‘hang’.

As the protocol isn't a standard request/response protocol, but more like a request/response triggered protocol, the turnaround delay is reduced by half of the value that would be encountered in a standard request/response protocol. (i.e. only the transmission delay and not transmission and reception delay). This is especially advantageous when the network is heavily loaded.

By having an appropriately set response timer dependent on the reception of requests the sending of responses are also kept to a reasonable level depending on the interest of the client.

Similarly, the send timers and response timer are set so that requests for status are sent at reasonably short intervals and that blocking of DCOM calls are made fast in a safe way.

The present invention has been described in the context of checking network failures. It is however possible to use the principles of the present invention to check other types of status of the server and the server application. In this case the request for status and the response to the request would contain more information in the data section or payload of the message.

The invention has furthermore been described in the context of TCP/IP and UDP/IP. It should however be realized that it can be used with any session oriented computer protocol.

The invention has been described in relation to just two computers. The invention can be used on more computers depending on how many computers different applications on the client need to request processing from.

The invention has been described in relation to DCOM. The invention can however be used for other middleware applications that induce their own retry mechanism out of the immediate control of the ‘user application’.

1. Method of forestalling long time-outs in a process run on at least a first computing device in a network, which process makes calls for processing to a second computing device, and comprising the steps of:
sending a request for status to a second computing device, and
in case of no response on the request for status from the second computing device automatically blocking requests for processing of data to be sent the second computing device.

2. Method according to claim 1, including the step of generating a request for processing of data which causes the sending of the request for status.

3. Method according to claim 1, wherein the request for status comprises a request for information about a network connection of the second computing device and the response on the request for status comprises information about the network connection from the second computing device.

4. Method according to claim 1, further including the step of setting a time limit within which the response to the request for status is to be received and the step of blocking requests for processing is performed if no response is received within the time limit.

5. Method according to claim 4, wherein the second computing device has a time limit within which responses are to be sent to the first computing device and the time limit within which the response is to be received is between two and three times longer than the send time limit of the second computing device.

6. Method according to claim 1, further including the step of setting a time limit within which a request for status is to be sent and the sending of a request for status is performed when this time limit expires.

7. Method according to claim 1, wherein requests for status are sent using a simplified first protocol and requests for processing are sent using a second standard protocol.

8. Method of determining status of a computing device used for receiving calls for processing from another computing device via a network, comprising the steps of:
receiving a request for status from the other computing device,
generating at least one response to the request, and
sending the response to the other computing device.

9. Method according to claim 8, wherein requests for status and responses to these requests are received and sent using a first simplified protocol.

10. Method according to claim 8, wherein the step of generating includes generating more than on response within a request time limit without waiting for further requests.

11. Method according to claim 10, wherein the time for responding to a request is reset each time a request for status is received.

12. Method according to claim 10, wherein the other computer has a send time limit determining when requests for status are to be sent and said request time limit is between one and two times longer than this send time limit.

13. Method according to claim 8, further including the step of setting a time limit for sending a response and sending the response when said time limit expires.

14. Computing device for connection to other computing devices via a network comprising:
an application unit performing computational tasks and making requests for processing to another computer device,
a status determining unit connected to the application unit and arranged to
send a request for status to the other computing device, which other computing device is to perform a computational task for the application unit, and
automatically block request for processing of data to the other computing device if no response is received from the other computing device, which request for processing is caused by the application unit.

15. Computing device for connection to other computing devices via a network and comprising:
an application unit performing computational tasks for another application unit when being requested to do so by the other computing device, and
a status responding unit arranged to
receive a request for status from the other computing device,
generate at least one response to the request, and
send the response to the other computing device.

16. System of computing devices including at least a first and a second computing device connected to each other via a network,
the first computing device comprising:
an application unit performing computational tasks,
a status determining unit connected to the application unit and arranged to
send a request for status to the second computing device, which second computing device is to perform some computational tasks for the application unit, and
automatically block request for processing of data to the second computing device if no response is received from the second computing device, which request for processing is caused by the application unit,
the second computing device comprising:
an application unit performing computational tasks for the first application unit, and
a status responding unit arranged to
receive the request for status from the first computing device,
generate at least one response to the request, and
send the response to the first computing device.

17. A program product comprising a computer readable medium, having thereon: computer program code means, to make a computer execute, when said program is loaded in the computer:
sending of a request for status to another computer, and
in case of no response on the request for status from the other computer, automatically blocking requests for processing of data to the other computer.

18. A program product comprising a computer readable medium, having thereon: computer program code means to make a computer execute, when said program is loaded in the computer:
receiving a request for status from another computer,
generating at least one response to the request, and
sending the response to the other computer.
